(19) United States
(12) Patent Application Publication
(10) Pub. No.: US 2026/0350348 A1
(43) Pub. Date: Nov. 5, 2026

(54) RESERVOIR COMPUTING DEVICE, RESERVOIR COMPUTING PROGRAM, AND RESERVOIR UTILIZATION CALCULATION METHOD

(71) Applicant: Kyushu Institute of Technology, Kitakyushu-shi, Fukuoka (JP)

(72) Inventors: Hakaru Tamukoh, Kitakyushu-shi, Fukuoka (JP); Takashi Morie, Kitakyushu-shi, Fukuoka (JP); Yuichiro Tanaka, Kitakyushu-shi, Fukuoka (JP); Ichiro Kawashima, Kitakyushu-shi, Fukuoka (JP); Osamu Nomura, Kitakyushu-shi, Fukuoka (JP)

(73) Assignee: Kyushu Institute of Technology, Kitakyushu-shi, Fukuoka (JP)

(21) Appl. No.: 19/487,962

(22) PCT Filed: May 2, 2024
(86) PCT No.: PCT/JP2024/016884

§ 371 Date: Nov. 25, 2025

(30) Foreign Application Priority Data
May 30, 2023 (JP) 2023-088827

(51) Int. Cl. G06N 3/044; G06N 3/04

(52) U.S. Cl. CPC G06N 3/044; G06N 3/0418

(57) ABSTRACT

A reservoir computing device 10 includes: an input layer 11; a reservoir layer 12 that outputs a signal reflecting the signal given from the input layer 11; and an output layer 13 that derives an output value based on the signal outputted from the reservoir layer 12. The input layer 11 has a plurality of nodes A (nodes 14 to nodes 14f). At least one node A is given a signal reflecting the signal outputted from another node A in one step, and the signal reflecting the given signal is given to the reservoir layer in a subsequent step.

### TECHNICAL FIELD

The present invention relates to a reservoir computing device that performs information processing based on a reservoir computing model, a reservoir computing program, and a reservoir utilization calculation method.

### BACKGROUND ART

In a recurrent neural network having recurrent connections, a reservoir computing model is known as a computing model of machine learning suitable for processing time-series information (see patent literature 1). The reservoir computing model includes: a reservoir layer having a plurality of nodes that are connected to each other; and an output layer that derives an output value based on information that reflects a state of the respective nodes (neurons) of the reservoir layer. The reservoir computing model makes an output value approach a target value by adjusting connection weights between the reservoir layer and the output layer.

The state of each node in the reservoir layer (hereinafter the node in the reservoir layer is simply referred to as “node”) changes corresponding to information inputted to the reservoir layer and information given from another node. Information that each node gives to another node corresponds to a state of the node that reflects information inputted to the reservoir layer in the past and information given to the node from another node in the past. Accordingly, the reservoir layer retains the past information. An amount of the past information that the reservoir computing model can retain is evaluated as the magnitude of the memory capacity of the reservoir layer.

### CITATION LIST

### Patent Literature

[Patent literature 1] Japanese Patent No. 7028377

### Non-Patent Literature

[Non-Patent Literature 1] Suzuki, H., Imura, Ji., Horio, Y. et al. Chaotic Boltzmann machines. Sci Rep 3, 1610 (2013). https://doi.org/10.1038/srep01610
[Non-Patent Literature 2] Y. Katori, H. Tamukoh and T. Morie, “Reservoir Computing Based on Dynamics of Pseudo-Billiard System in Hypercube,” 2019 International Joint Conference on Neural Networks (IJCNN), Budapest, Hungary, 2019, pp. 1-8, doi: 10.1109/IJCNN.2019.8852329.
[Non-Patent Literature 3] Kamimura Daichi, Yamaguchi Masatoshi, Katori Yuichi, Tamukoh Hakaru, Morie Takashi, “A CMOS Chaotic Boltzmann Machine Circuit Applied to Reservoir Computing”, IEEJ Electronic Circuits Study Group, ECT-19-089, December 18-19 (18), 2019, Nihon University (Tokyo)
[Non-Patent Literature 4] Tanaka Gohei, “Concept of Reservoir Computing and Its Recent Trends”, The Journal of the Institute of Electronics, Information and Communication Engineers, No. 102, Feb. 1, 2019
[Non-Patent Literature 5] Tomoyuki Kubota, Kohei Nakajima, and Hirokazu Takahashi. Dynamical anatomy of narma10 benchmark task. arXiv preprint arXiv: 1906.04608, 2019.

### SUMMARY OF INVENTION

### Technical Problem

As elements for evaluating the performance of a reservoir in a reservoir computing model, a memory capacity of a reservoir layer and a non-linear transformation characteristic of the reservoir layer are named as examples. However, there is a tendency for a memory capacity of the reservoir layer to be decreased as the non-linear transformation characteristic of the reservoir layer is increased. Accordingly, there is a demand for the reservoir computing model to satisfy a condition that both a non-linear transformation characteristic and a memory capacity of the reservoir layer exceed a certain level.

Accordingly, the present invention has been made in view of the foregoing circumstances, and it is an object of the present invention to provide a reservoir computing device, a reservoir computing program, and a reservoir utilization calculation method capable of stably maintaining a memory capacity above a certain level even when a non-linear transformation characteristic is increased.

### Solution to Problem

A reservoir computing device according to a first invention that conforms to the above-mentioned object is a reservoir computing device that includes: an input layer; a reservoir layer that outputs a signal reflecting the signal given from the input layer; and an output layer that derives an output value based on the signal outputted from the reservoir layer, wherein the input layer has a plurality of nodes A, at least one node A is given a signal reflecting the signal outputted from another node A in one step, and a signal reflecting the given signal is given to the reservoir layer in a subsequent step.

A reservoir computing program according to a second invention that conforms to the above-mentioned object enables an information processing terminal that includes an input means that has a plurality of nodes A, a reservoir means that outputs a signal reflecting a signal that is given from the input means, and an output means that derives the output value based on the signal outputted from the reservoir means to perform processing that includes: a step where at least one node A is given a signal reflecting a signal outputted from another node A; and a step where the node A to which the signal is given gives a signal reflecting the given signal to the reservoir means.

A reservoir utilization calculation method according to a third invention that conforms to the above-mentioned object is a reservoir utilization calculation method for deriving an output value based on an input signal inputted externally. The method includes: a step of allowing a first node to give an M-th input signal inputted to a first node externally to a reservoir operation unit, and allowing the first node to output the M-th input signal to a second node; and a step of allowing the first node to give a (M+1)-th input signal inputted to the first node externally to a reservoir operation unit, allowing the first node to output the (M+1)-th input signal to the second node, and further, allowing the second node to give a signal reflecting the M-th input signal to the reservoir operation unit.

### Advantageous Effects of Invention

According to the reservoir computing device of the first invention, the input layer has the plurality of nodes A, at least one node A is given the signal reflecting the signal outputted from another node A in one step, and the signal reflecting the given signal is given to the reservoir layer in the subsequent step. Accordingly, even when the non-linear transformation characteristic is increased, it is possible to stably possess a memory capacity to a certain extent or more.

Further, according to the reservoir computing program of the second invention, there is provided the information processing terminal that includes: the input means that has the plurality of nodes A, the reservoir means that outputs a signal reflecting a signal given from the input means; and the output means that derives an output value based on the signal outputted from the reservoir means. The reservoir computing program enables the information processing terminal to perform the processing that includes: the step where at least one node A is given a signal reflecting a signal outputted from another node A; and the step where the node A to which the signal is given gives a signal reflecting the given signal to the reservoir means. Accordingly, even when the non-linear transformation characteristic is increased, it is possible to stably possess a memory capacity to a certain extent or more.

Further, the reservoir utilization calculation method of the third invention includes: the step of allowing the first node to give an M-th input signal inputted to the first node externally to the reservoir operation unit, and allowing the first node to output the M-th input signal to the second node; and the step of allowing the first node to give a (M+1)-th input signal inputted to the first node externally to the reservoir operation unit, allowing the first node to output the (M+1)-th input signal to the second node, and further, allowing the second node to give a signal reflecting the M-th input signal to the reservoir operation unit. Accordingly, even when the non-linear transformation characteristic is increased, it is possible to stably possess a memory capacity to a certain extent or more.

### BRIEF DESCRIPTION OF DRAWINGS

FIG. 1 is an explanatory view of a reservoir computing device according to a first embodiment of the present invention.

FIG. 2 is an explanatory view of a reservoir computing device according to a second embodiment of the present invention.

FIG. 3 is an explanatory view of a modification of the reservoir computing device according to the second embodiment of the present invention.

FIG. 4 is an explanatory view of a reservoir computing device according to a third embodiment of the present invention.

FIG. 5 is an explanatory view of a reservoir computing device according to a fourth embodiment of the present invention.

FIG. 6 is an explanatory view illustrating a measurement result of memory capacities of respective models relating to a Chaotic Boltzman Machine as a graph.

FIG. 7 is an explanatory view illustrating a measurement result of NMSEs of respective models relating to a Chaotic Boltzman Machine as a graph.

FIG. 8 is an explanatory view illustrating a measurement result of memory capacities of respective models relating to an Echo State Network as a graph.

FIG. 9 is an explanatory view illustrating a measurement result of NMSEs of respective models relating to an Echo State Network as a graph.

FIG. 10 is an explanatory view of an example where the reservoir computing device according to the second embodiment of the present invention and the reservoir computing device according to the third embodiment of the present invention are combined with each other.

### DESCRIPTION OF EMBODIMENTS

Subsequently, an embodiment that embodies the present invention is described with reference to attached drawings for facilitating the understanding of the present invention.

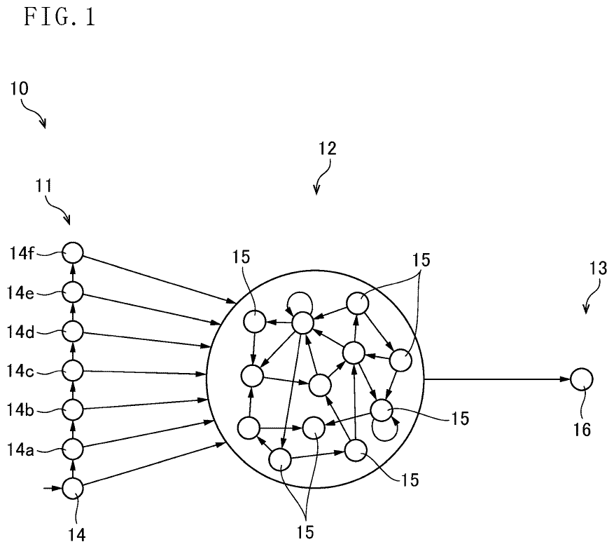

As illustrated in FIG. 1, a reservoir computing device 10 according to the first embodiment of the present invention is a device that includes: an input layer (input unit) 11; a reservoir layer (reservoir operation unit) 12 that outputs a signal reflecting a signal given from the input layer 11; and an output layer (output unit) 13 that derives an output value based on a signal outputted from the reservoir layer 12. Hereinafter, the reservoir computing device 10 is described in detail.

As illustrated in FIG. 1, in the reservoir computing device 10, the input layer 11 includes a plurality of (in this embodiment, seven input layers 11) of nodes 14, 14a, 14b, 14c, 14d, 14e, 14f (an example of a node A). The reservoir layer 12 also includes a plurality of nodes 15 (an example of a node B). The output layer 13 also includes a plurality of nodes 16. Although the output layer 13 is illustrated in FIG. 1 as if the number of nodes 16 that the output layer 13 includes is one, in the actual configuration, a plurality of nodes 16 exist. The nodes 14, 14a, 14b, 14c, 14d, 14e, 14f are each capable of acquiring a signal, storing the acquired signal, and outputting the signal.

In this embodiment, the nodes 14, 14a, 14b, 14c, 14d, 14e, 14f perform signal processing with a predetermined period T (time interval T). To be more specific, at a N-th step, the node 14 (and also, the nodes 14a, 14b, 14c, 14d, 14e, 14f) is given a new signal (acquires the new signal), stores the signal, and outputs a signal that was given and stored at a (N−1)-th step (one preceding step) at the N-th step. Here, N is a natural number.

The input layer 11 is designed such that, with the period T, the node 14 is given a signal externally, outputs the signal to the node 14a and the reservoir layer 12, the node 14a outputs a signal to the node 14b and the reservoir layer 12, the node 14c outputs a signal to the node 14d and the reservoir layer 12, the node 14d outputs a signal to the node 14e and the reservoir layer 12, and the node 14e outputs a signal to the node 14f and the reservoir layer 12.

Accordingly, after the node 14 is given a signal externally in the first step, the input layer 11 performs the following processing.

second step:
The node 14 is given a new signal externally, and outputs the signal given externally in the first step to the node 14a and the reservoir layer 12.
   third step:
The node 14 is given a new signal externally, and outputs the signal given externally in the second step to the node 14a and the reservoir layer 12. The node 14a outputs the signal given from the node 14 in the second step to the node 14b and the reservoir layer 12.
   fourth step:
The node 14 is given a new signal externally, and outputs the signal given externally in the third step to the node 14a and the reservoir layer 12. The node 14a outputs the signal given from the node 14 in the third step to the node 14b and the reservoir layer 12. The node 14b outputs the signal given from the node 14a in the third step to the node 14c and the reservoir layer 12.

The substantially same processing is performed in the fifth step and subsequent steps. That is, the node 14c outputs the signal given from the node 14b at the one preceding step to the node 14d and the reservoir layer 12. The node 14d outputs the signal given from the node 14c at the one preceding step to the node 14e and the reservoir layer 12. The node 14e outputs the signal given from the node 14d at the one preceding step to the node 14f and the reservoir layer 12. The node 14f outputs the signal given from the node 14e at the one preceding step to the reservoir layer 12.

Here, it is unnecessary to set timings at which the node 14, 14a, 14b, 14c, 14d, 14e, 14f output the signal equal. For example, the node 14, 14a, 14b, 14c, 14d, 14e, 14f can be designed such that the nodes 14, 14a, 14b, 14c output the signal given at one preceding step with a period T, and the node 14d, 14e, 14f output the signal given at two preceding steps with a period 2T.

Further, among all nodes A that the input layer includes, a plurality of nodes A may be given a signal externally. In this case, with respect to the nodes A other than the nodes A to which a signal is given externally, such nodes A are given a signal from other nodes A. Further, a signal may be outputted to the plurality of nodes A from one node A, or a signal which reflects a signal given in the past such as a signal obtained by multiplying a signal given to the node A by a constant may be outputted to other nodes A.

Accordingly, at least one node A is given a signal reflecting signal outputted from another node A is reflected in one step, or the given signal per se or a signal obtained by transforming the given signal, that is, a signal reflecting the given signal is given to the reservoir layer in the subsequent step. Accordingly, the input layer can give signals reflecting signals given to the input layer externally through the plurality of past steps (in this embodiment, node 14), or the signals reflecting the signals generated in the input layer over the plurality of the past steps to the reservoir layer.

Further, in this embodiment, the signals outputted from the node 14, 14a, 14b, 14c, 14d, 14e, 14f to the reservoir layer 12 are given to all or some nodes 15. The respective nodes 15 of the reservoir layer 12 output signals with respect to the acquisition of signals, a change of state, and signals to one or plurality of objects at a period T. Sources that give signals to the respective nodes 15 are the nodes 14, 14a, 14b, 14c, 14d, 14e, 14f, the node 15 per se, one or a plurality of other nodes 15. The output destination of the signal of each node 15 is the node 15 per se, another node 15 and the output layer 13.

Each node 15 is given a new signal at the N-th step, its state changes according to the given new signal and the state of the node 15 per se before the new signal is given, and the node outputs a signal corresponding to the changed state at the (N+1)-th step. Accordingly, the influence of the signals given to the reservoir layer 12 from the input layer 11 over the plurality of past steps remains in the reservoir layer 12.

As described above, in this embodiment, not only the reservoir layer 12 but also the input layer 11 retain the past signals (information) and hence, the reservoir computing device 10, as a whole, can stably maintain a memory capacity above a certain level even when the non-linearity transformation characteristic of the reservoir layer 12 is increased.

Further, a signal that the node 15 (reservoir layer 12) outputs to the output layer 13 is multiplied by a connection weight corresponding to the signal, and the signal is given to the output layer 13. In FIG. 1, the description is made assuming that the signal is given from the reservoir layer 12 to the output layer 13 through a single path. However, in the actual configuration, a plurality of paths are provided, and the node 15 is configured such that an individual connection weight corresponds to each path. The number of paths through which a signal is given from the reservoir layer 12 to the output layer 13 may be one.

The output layer 13, each time a plurality of signals are given from the reservoir layer 12 at the period T, derives an output value based on the plurality of given signals. In this embodiment, the output layer 13 derives an output value by adding the plurality of signals given from the reservoir layer 12 to the output layer 13 (the signals obtained by multiplying the signals outputted from the nodes 15 by connection weights). Accordingly, the reservoir computing device 10 applies a sum-of-product operation to the signals outputted from the reservoir layer 12, and derives the output value. During learning, the derived output value and a target value are compared with each other, and the values of connection weights corresponding to the respective signals outputted from the reservoir layer 12 are adjusted so as to make the output value approach the target value. Here, for example, in a case where a task that the reservoir computing device 10 performs is a prediction task, the output value becomes a predicted value.

Accordingly, a reservoir utilization calculation method that derives an output value based on an input signal externally using the reservoir computing device 10 includes: a step where the first node gives an M-th input signal inputted to the first node (node 14) externally to the reservoir operation unit (reservoir layer 12), and the first node outputs the M-th input signal to the second node (node 14a); and a step where the first node gives an (M+1)-th input signal inputted to the first node externally to the reservoir operation unit, the first node outputs the (M+1)-th input signal to the second node and, the second node gives a signal reflecting the (M-th) input signal to the reservoir operation unit. M is a natural number.

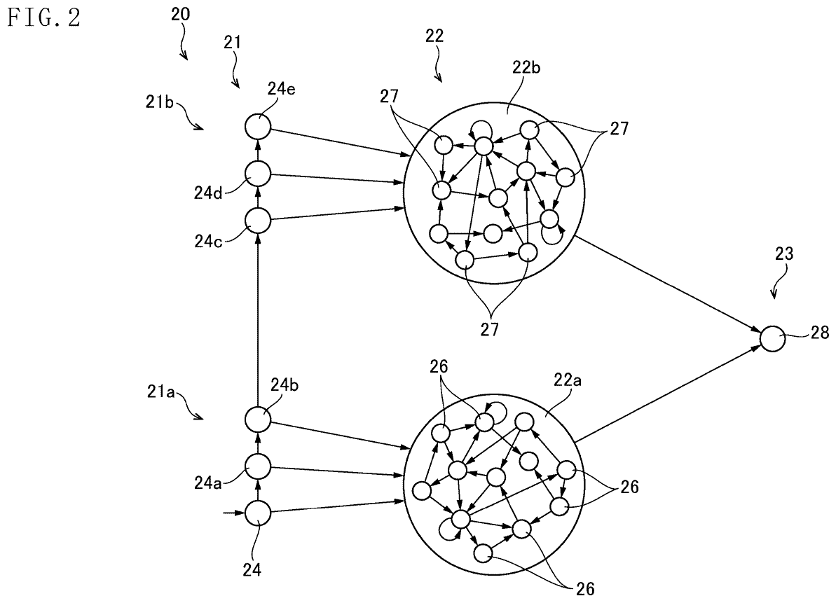

Next, a reservoir computing device 20 according to a second embodiment of the present invention is described with reference to FIG. 2.

As illustrated in FIG. 2, the reservoir computing device 20 includes: an input layer (input unit) 21, a reservoir layer (reservoir operation unit) 22 that outputs a signal reflecting a signal given from the input layer 21; and an output layer (output unit) 23 that derives an output value based on a signal outputted from the reservoir layer 22.

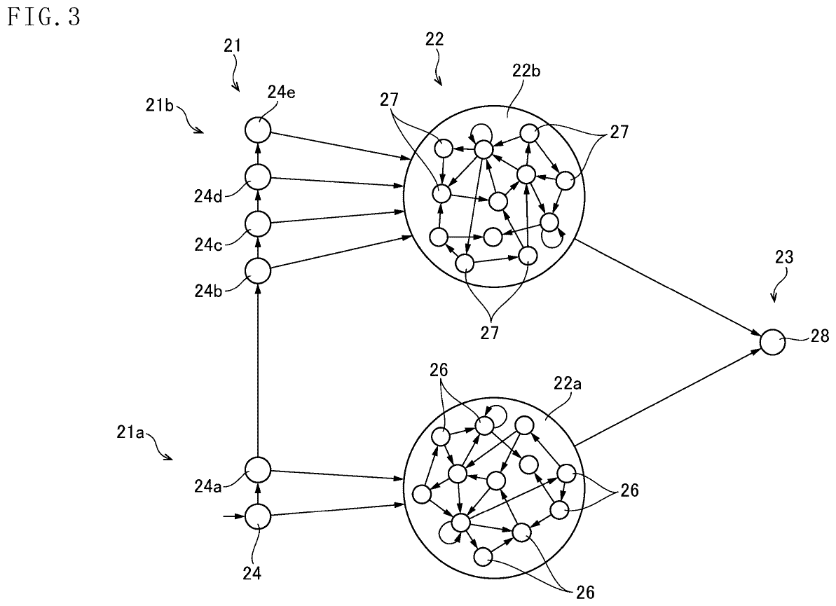

The input layer 21 consists of a plurality of (in this embodiment, 2) groups, and the reservoir layer 22 also consists of a plurality of (in this embodiment, 2) groups. In this embodiment, the number of groups in the input layer 21 and the number of groups in the reservoir 22 are equal. The input means 21a that corresponds to the first group of the input layer 21 has a plurality of nodes 24, 24a, 24b, and an input means 21b that corresponds to the second group of the input layer 21 includes a plurality of nodes 24c, 24d, 24e. In this embodiment, in the input layer 21, the number of nodes that the input means 21a has and the number of nodes that the input means 21b has are equal. As illustrated in FIG. 3, these numbers of nodes may differ from each other.

The reservoir means 22a that corresponds to the first group of the reservoir layer 22 includes a plurality of node 26, and the reservoir means 22b that corresponds to the second group of the reservoir layer 22 includes a plurality of nodes 27. The output layer 23 has one node 28. The number of the nodes 26 may be equal to the number of the nodes 27 or may differ from the number of the nodes 27. The output layer 23 may have a plurality of nodes 28.

A signal externally is given to the node 24, the node 24 outputs the signal to the node 24a and the reservoir means 22a. The node 24a outputs the signal to the node 24b and the reservoir means 22a, and the node 24b outputs a signal to the node 24c and the reservoir means 22a. The node 24c outputs a signal to the node 24d and the reservoir means 22b, the node 24d outputs a signal to the node 24e and the reservoir means 22b, and the node 24e outputs a signal to the reservoir means 22b.

The reservoir means 22a is configured such that the plurality of nodes 26 behave substantially in the same manner as the plurality of nodes 15 in the input layer 12 in the reservoir computing device 10, and outputs a signal to the node 28 of the output layer 23. The reservoir means 22b is also configured such that the plurality of nodes 27 behave substantially in the same manner as the plurality of nodes 15 in the input layer 12 in the reservoir computing device 10, and outputs a signal to the node 28 of the output layer 23.

Accordingly, in this embodiment, each group in the reservoir layer 22 is given a signal only from a specific (corresponding) group in the input layer 21, and each group of the reservoir layer 22 outputs the signal to the common node 28 of the output layer 23. The output layer 23 (node 28) derives an output value based on the signals given from the reservoir means 22a, 22b. In this embodiment, outputting of signals of the respective nodes 24, 24a, 24b, 24c, 24d, 24e, 26, 27 are all performed at a period T. However, such outputting may be performed at different periods. For example, only outputting of a signal from the node 24b to the node 24c, outputting of a signal from the node 24c to the node 24d and outputting of a signal from the node 24d to the node 24e are performed during a period 2T twice as large as the period T, and outputting of other signals may be performed at a period of T.

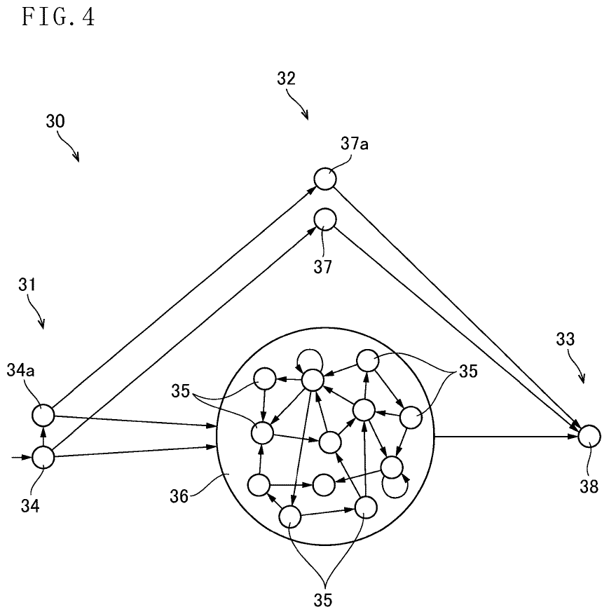

Next, a reservoir computing device 30 according to a third embodiment of the present invention is described with reference to FIG. 4.

As illustrated in FIG. 4, the reservoir computing device 30 includes: an input layer (input unit) 31, a reservoir layer (reservoir operation unit) 32 that outputs a signal reflecting a signal given from the input layer 31, and an output layer (output unit) 33 that derives an output value based on a signal outputted from the reservoir layer 32.

An input layer 31 has a plurality of (in this embodiment, 2) nodes 34, 34a (an example of respective nodes A). The reservoir layer 32 includes: a reservoir means 36 that includes a plurality of nodes 35 (an example of nodes B); and nodes 37, 37a (one example of respective nodes C) to which signals are directly given from the nodes 34, 34a. The node 37 is not connected to another node 37a in the reservoir layer 32, and the node 37a is not connected with another node 37 in the reservoir layer 32.

The output layer includes one node 38. The reservoir means 36 performs substantially the same processing as the reservoir means 22 or the reservoir means 22a in the reservoir computing device 20 and outputs a signal (one or a plurality of signals) to the output layer 33. The reservoir computing device 30 performs processing in the following steps.

### First Step:

A signal is given to the node 34 externally.

### Second Step:

The node 34 is given a new signal externally and outputs the signal given externally in the first step to the node 34a, the reservoir means 36 and the node 37. The signal that the node 34 outputs may be directly given to the node 37, or the signal outputted from the node 34 may be multiplied by a connection weight, and such a signal maybe given to the node 37. This may be substantially applicable to the relationship between the node 34a and the node 37a.

### Third Step:

The node 34 is given a new signal externally and outputs the signal given externally in the second step to the node 34a, the reservoir means 36 and the node 37. The node 34a outputs the signal given from the node 34 in the second step to the reservoir means 36 and the node 37a. The node 37 outputs the signal given from the node 34 in the second step to the output layer 33.

### Fourth Step:

The node 34 is given a new signal externally and outputs the signal given externally in the third step to the node 34a, the reservoir means 36 and the node 37. The node 34a outputs the signal given from the node 34 in the third step to reservoir means 36 and the node 37a. The node 37 outputs the signal given from the node 34 in the third step to the output layer 33. The node 37a outputs the signal given from the node 34 in the third step (that is, the signal given to the node 34a from the node 34 in the second step) to the output layer 33.

In the steps subsequent to the fourth step, when the reservoir means 36 begins to output the signal to the output layer 33, the signals respectively outputted from the nodes 37, 37a and the reservoir means 36 in the step are multiplied by connection weights corresponding to the signals respectively, and the multiplied signals are given to the output layer 33. Then, in the output layer 33, the node 38 derives an output value based on the signals given to the output layer 33. The adjustment of the respective connection weights by comparison of the output value and a target value during learning is performed substantially in the same manner as the reservoir computing device 10.

Accordingly, the reservoir layer 32 includes a node C (in this embodiment, nodes 37, 37a) that is given the signals from the node A (in this embodiment, the nodes 34, 34a) in one step, and outputs the signal reflecting the given signal (in this embodiment, the given signal per se or a signal obtained by multiplying the given signal by a predetermined numerical value) to the output layer 33 in the subsequent step. Accordingly, in the reservoir computing device 30, not only the reservoir means 36 but also the node 37, 37a also have a function of maintaining the signal reflecting the signal given to the node 34 from the outside in the past (or the signal that the node 34 generates in the past).

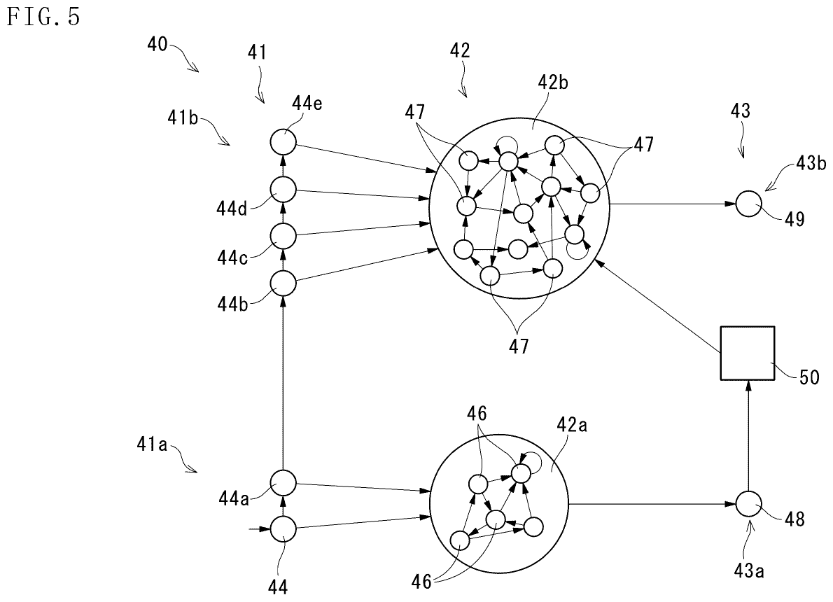

Next, a reservoir computing device 40 according to a fourth embodiment of the present invention is described with reference to FIG. 5.

As illustrated in FIG. 5, the reservoir computing device 40 includes: an input layer (input unit) 41, a reservoir layer (reservoir operation unit) 42 that outputs a signal reflecting a signal given from the input layer 41, and an output layer (output unit) 43 that derives an output value based on a signal outputted from the reservoir layer 42.

The input layer 41, the reservoir layer 42 and the output layer 43 consist of a plurality of (in this embodiment, 2) groups respectively. In this embodiment, the number of groups in the input layer 41, the number of groups in the reservoir layer 42, and the number of groups in the output layer 43 are equal. An input means 41a that constitutes the first group in the input layer 41 has a plurality of nodes 44, 44a, and an input means 41b that constitutes the second group in the input layer 41 has a plurality of nodes 44b, 44c, 44d, 44e. Accordingly, the input means 41b, compared to input means 41a, has a larger number of nodes and can retain a larger amount (number) of signals.

The reservoir means 42a that constitutes a first group (group Q) of the reservoir layer 42 includes a plurality of nodes 46, and the reservoir means 42b that constitutes a second group (group P) of the reservoir layer 42 includes a plurality of nodes 47. The number of nodes 47 is larger than the number of nodes 46 and hence, the reservoir means 42b can perform a complicated arithmetic operation compared to the reservoir means 42a. A signal is given to the reservoir means 42a from the input means 41a, and a signal is given to the reservoir means 42b from the input means 41b.

An output means 43a that constitutes a first group of the output layer 43 has one node 48 (or may have a plurality of nodes 48), and an output means 43b that constitutes a second group of the output layer 43 has one node 49 (or may have a plurality of nodes 49). The output means 43a derives an output value that corresponds to the reservoir means 42a and is based on a signal given from the reservoir means 42a. The output means 43b derives an output value that corresponds to the reservoir means 42b and is based on a signal given from the reservoir means 42b.

The reservoir means 42a is normally in an activated state where the reservoir means 42a can perform various processing (including processing where the reservoir means 42a is given a signal from the input means 41a and outputs the signal to the output means 43a) regardless of whether the reservoir means 42a is given a signal from the input means 41a.

To the contrary, when the reservoir means 42b receives a predetermined signal from an activation means 50 connected to the output means 43a, the reservoir means 42b is brought into an activated state where various processing (including processing where the reservoir means 42b is given a signal from the input means 41b and outputs the signal to the output means 43b) can be performed, and the reservoir means 42b is switched from the activated state to a sleep state where various processing (including processing where the reservoir means 42b is given a signal from the input means 41b and outputs the signal to the output means 43b) are not performed under a predetermined condition.

The condition that the reservoir means 42b is switched from the activated state to the sleep state is that, for example, a signal is not inputted from the input means 41b to the reservoir means 42b for a preset time (period) or a predetermined signal is given to the reservoir means 42b.

When the output means 43a derives a preset output value or when the output value is given to the activation unit 50, the activation unit 50 generates a signal that brings the reservoir means 42b in a sleep state into an activated state. That is, the reservoir means 42b in a sleep state is switched to an activated state when the output means 43a to which the signal is outputted from the reservoir means 42a derives the preset output value.

The reservoir means 42b in an activated state is configured such that, based on signals outputted from the nodes 44b to 44e to the reservoir means 42b, the respective nodes 47 behave similarly as the plurality of nodes 15 in the reservoir layer 12 in the reservoir computing device 10, and output the signals to the output means 43b.

In this embodiment, the entire reservoir computing device 40 that contains the reservoir means 42b accompanies power consumption in various processing, and an electric energy that the reservoir means 42b consumes is greater in the activated state than in the sleep state. Accordingly, the reservoir computing device 40 is, in principle, preferred from a viewpoint of energy saving compared to a reservoir computing device where all of a plurality of reservoir means are in an activated state.

Further, in this embodiment, a task of the reservoir means 42a is limited only to the activation of the reservoir means 42b in a sleep state.

The task of the reservoir means 42b is complicated compared to the task of the reservoir means 42a, and the number of nodes in the reservoir means 42b is large compared to the number of nodes in the reservoir means 42a. Hence, the power consumption in an activated state by the reservoir means 42b is large compared to the power consumption in an activated state by the reservoir means 42a.

From this point of view, the reservoir computing device 40 adopts a design preferable from a viewpoint of energy saving.

To activate the reservoir means 42b in a sleep state, a signal given to the reservoir computing device 40 (to be more specific, the node 44) externally is, for example, a signal converted from the voice of a predetermined character string, or a signal converted from a predetermined input generated from an operation of an input device.

The reservoir computing devices 10, 20, 30, 40 described above are designed to perform processing based on Chaotic Boltzmann Machine described in non-patent literatures 1, 2 and 3. The Chaotic Boltzmann Machine is a network constituted of nonlinear oscillators based on billiard dynamics, and the application of Chaotic Boltzmann Machine to a reservoir computing device has been proposed. However, the reservoir computing device is not limited to such a design. For example, the reservoir computing device may be designed to perform processing based on an echo state network or a liquid state machine described in non-patent literature 4. The echo state network and the liquid state machine are known as representative models for realizing the reservoir computing device.

Further, the reservoir computing devices 10, 20, 30, 40 are constituted of a computer (one example of an information processing terminal) that is a hardware and a software program and the like implemented in the computer. However, the reservoir computing device may be constituted of physical mounting (analogue circuit, semiconductor optical amplifier, cellular automaton, nanoscale materials or the like) (that is, embodying of a physical reservoir). Signals adopted by the reservoir computing devices 10, 20, 30, 40 be an analog signal or a digital signal.

When the reservoir computing device is constituted of a computer, a software program and the like, the software program (reservoir computing program), to derive an output value based on a given signal, enables the computer to function as an input means having a plurality of nodes A, a reservoir means that outputs a signal reflecting a signal given from the input means, and an output means that derives an output value based on the signal given from the reservoir means, and to perform; a step where at least one node A is given a signal reflecting a signal outputted from other node A; and a step where the node A that was given the signal gives a signal reflecting the given signal to the reservoir means.

Further, the above-mentioned software program includes a plurality of input means and a plurality of reservoir means, and can enable the computer to execute processing where the plurality of reservoir means respectively give a signal only from the specific input means.

Then, the above-mentioned software program has the plurality of a reservoir means, and the plurality of reservoir means consists of: a reservoir means p that is switched from an activated state where the signal is given from the input means and the signal is outputted to the output means to a sleep state where processing of outputting the signal is not performed even when the signal is given from the input means; and a reservoir means q where the reservoir layer is in the activated state normally. The software program makes the computer execute processing of switching the reservoir means p in a sleep state to an activated state by allowing the output means to which the signal is outputted from the reservoir means q to derive a preset output value.

Further, the above-mentioned software program makes the computer function also as the node C to which a signal is directly given from the node A, and can make the computer execute processing where the node C outputs a signal reflecting the signal given to the node C to the output means, and limits a transmission source that transmits the signal to the node C only to the node A, and limits an output destination of the signal from the node C only to the output means.

### Experiment Example

Next, two experiments based on simulations using a computer that are performed for checking the manner of operation and advantageous effects of the present invention are described.

In the first experiment, with respect to a reservoir computing model (comparison example 1) that is constituted of a Chaotic Boltzmann Machine indicated in the following table 1 and reservoir computing models (experiment examples 1 to 4) to which Chaotic Boltzmann Machine is applied and indicated in the following table 1, a memory capacity and a normalized mean square error (NMSE) that are evaluation values relating to an extent of the duration in which inputted information could be stored were measured.

TABLE 1

| | | whether input layer | | |
|---|---|---|---|---|
| | | retain past signal | | number of |
| | | (total number of | whether reservoir | groups in |
| | model type | delay stages of | layer has nodes C | reservoir |
| CBM-RC | (legend) | input layer) | (number of nodes C) | layer |
| comparison | CBM | No | No | 1 |
| example 1 | | (1) | (0) | |
| experiment | delay-CBM | Yes | No | 1 |
| example 1 | | (10) | (0) | |
| experiment | delay-cluster-CBM | Yes | No | 5 |
| example 2 | | (10) | (0) | |
| experiment | delay-passthru-CBM | Yes | Yes | 1 |
| example 3 | | (10) | (10) | |
| experiment | delay-passthru- | Yes | Yes | 5 |
| example 4 | cluster-CBM | (10) | (10) | |

Further, also with respect to an echo state network model (comparison example 2) and models (experimental examples 5 to 8) to which an echo state network model was applied all indicated in the following table 2, a memory capacity and an NMSE were measured.

TABLE 2

| | | whether input layer | | |
|---|---|---|---|---|
| | | retain past signal | | number of |
| | | (total number of | whether reservoir | groups in |
| | model type | delay stages of | layer has nodes C | reservoir |
| CBM-RC | (legend) | input layer) | (number of nodes C) | layer |
| comparison | ESN | No | No | 1 |
| example 2 | | (1) | (1) | |
| experiment | delay-ESN | Yes | No | 1 |
| example 5 | | (10) | (1) | |
| experiment | delay-cluster-ESN | Yes | No | 5 |
| example 6 | | (10) | (1) | |
| experiment | delay-passthru-ESN | Yes | Yes | 1 |
| example 7 | | (10) | (10) | |
| experiment | delay-passthru- | Yes | Yes | 5 |
| example 8 | cluster-ESN | (10) | (10) | |

In the model type indicated in Table 1, CBM means a reservoir computing model to which Chaotic Boltzmann Machine was applied, and in the model type indicated in Table 2, ESN means an echo state network.

An input wave form, a target waveform and a predicted waveform were set as follows. Of the total time length of 1500, a time length of 1000 was set as a learning time, and a remaining time length of 500 was set as the measurement time of the memory capacity and the NSME. Based on a ridge regression with respect to a predicted waveform portion outputted from a reservoir computing model and a target waveform portion corresponding to the predicted waveform during the measurement time of the memory capacity and the NMSE, the memory capacity and the NSME were derived.

Input waveform: A uniform random number sequence from 0.0 to 0.2 was generated with an amount corresponding to the time length of 1500, and the uniform random number sequence was set as an input waveform inputted to the reservoir computing model that becomes an object.

Target waveform: A waveform generated by applying the uniform random number sequence generated for forming the input waveform to a function expressed by the following formula 1 was set as the target waveform. [Formula 1]

$$y ( n + 1 ) = α y ( n ) + β y ( n ) ( {\sum }_{t = 0}^{T - 1} y ( n - t ) ) + γα ( n - T + 1 ) u ( t ) + δ \qquad ( Formula 1 )$$

$$α = 0.3 , β = 0.05 , γ = 1.5 , δ = 0.1$$

In the formula 1, y is the target waveform, and u is the input waveform. T represents the maximum step number that indicates the extent to which the past steps are reflected retroactively. In this experiment, T is set to 10 (T=10).

Predicted waveform: A waveform that is outputted by inputting the input waveform to the reservoir computing model was set as the predicted waveform.

Further, in each reservoir computing model, a connection weight value Win between the input layer and the reservoir layer, a connection weight value Wrec between the nodes in the reservoir layer, and a connection weight value Wout between the reservoir layer and an output layer were set as follows.

Win: A matrix was generated by uniform random numbers −1 to 1, and a product obtained by multiplying the matrix by ai was set as Win.

Wrec: Three values consisting of −1, 0, and 1 were arranged in the matrix at the density of Br, and a spectral radius was measured and was set as Wrec.

Wout: Wout before learning was set equal to Win. Wout after learning was set to a value obtained by ridge regression.

An operation from the generation of an input waveform to the derivation of a memory capacity and an NMSE was repeated 10 times, and an average value of the 10 derived memory capacities and an average value of the derived 10-time NMSE were set as a final memory capacity and a final NMSE.

The number of nodes in the input layer was 1, the number of nodes in the reservoir layer was 200, and the number of nodes in the output layer was 1. Further, using a simplex method that is a technique for solving a linear programming problem, respective parameters of reservoir computing model were adjusted by setting NARMA10 as a target. NARMA10 is a task that predicts a future value of time-series data that uses a nonlinear auto regressive moving average (NARMA) model as described in non-patent literature 5, and is used as a performance evaluation task of the reservoir computing model.

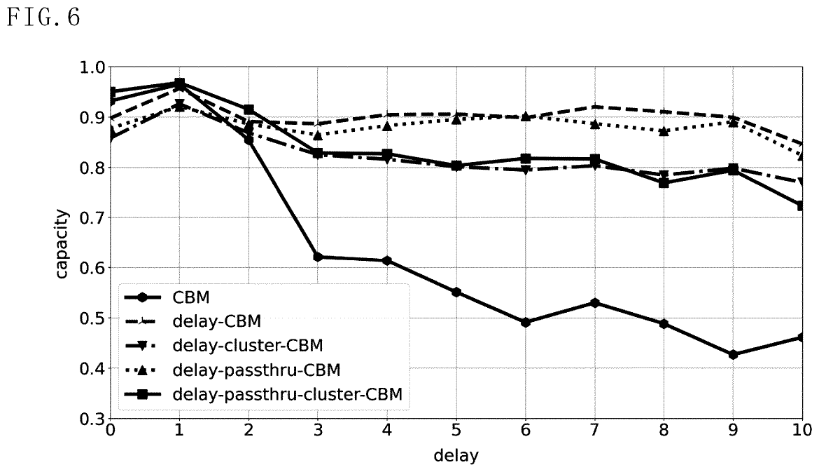

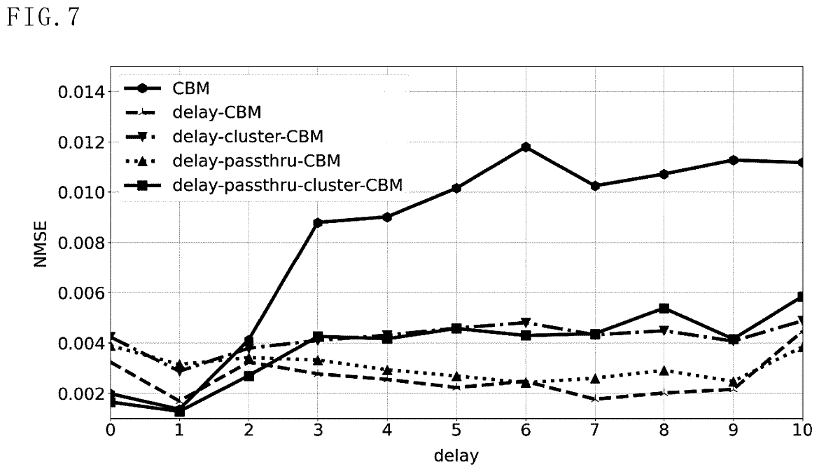

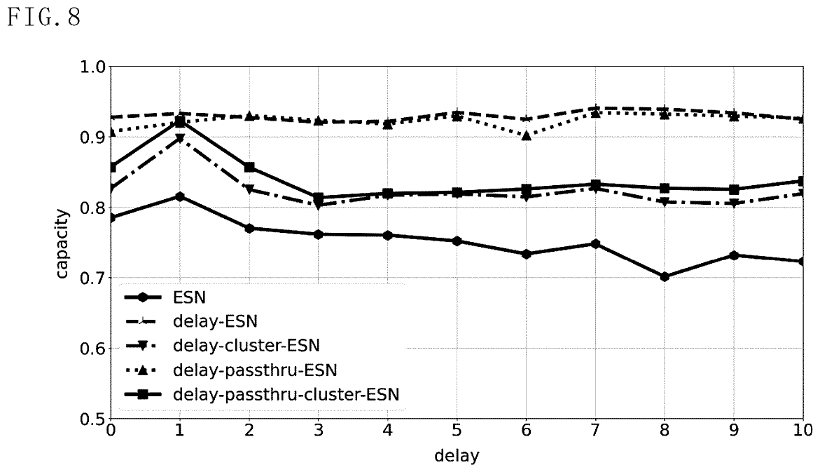

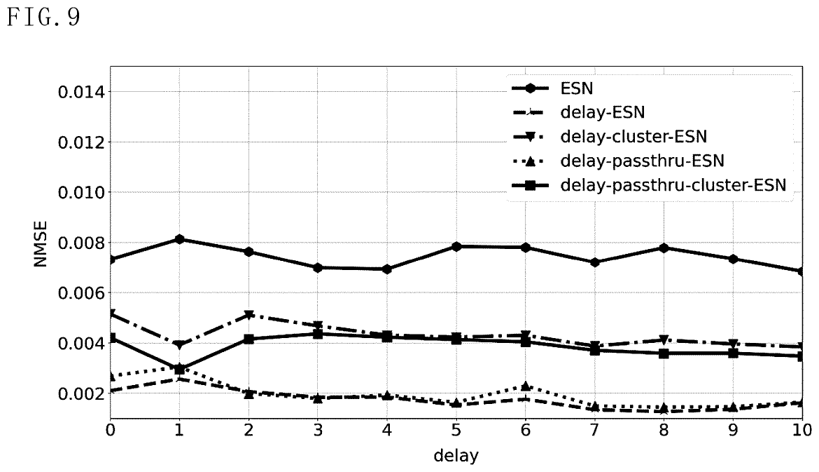

A measurement result of a memory capacity and a measurement result of an NMSE with respect to the reservoir computer models (comparison example 1 and experiment examples 1 to 4) relating to Chaotic Boltzmann Machine are illustrated in FIG. 6 and FIG. 7 respectively. Further, a measurement result of a memory capacity and a measurement result of an NMSE of models (comparison example 2 and experiment examples 5 to 8) relating to ESN are illustrated in FIG. 8 and FIG. 9 respectively. Delay on an axis of abscissas in FIG. 6 to FIG. 9 corresponds to T in the formula 1.

The measurement result showed that, in the experiment examples 1 to 8, the value of the memory capacity and the value of NMSE were outstandingly improved (that is, the memory capacity was further increased and the NMSE was further decreased).

Further, in the second experiment, a reservoir computing model where two groups consisting of a group P (group where an activated state and a sleep state are switched) and a group Q (group where only a task that activates the group P was performed) was prepared. Both the number of nodes in the group P and the number of nodes in the group Q were 200. In the input layer, four nodes in total consisting of two nodes that give a signal to the group P and two nodes that give a signal to the group Q were provided.

A total of 300 samples of speech data (30 samples for each of the 10 digits from 0 to 9) obtained from six speakers were prepared. Each speech data was pre-processed using a Lyon Auditory Model and was transformed into a signal of 64-dimensions and 100 steps, and the signal was set as test data. As a result, 300 test data were prepared.

The reservoir layer was set such that, only when test data given to the input layer was a specific number, (for example, numeral: 0) with respect to the group Q of the reservoir layer (hereinafter simply referred to as “group Q”), the group P in the reservoir layer (hereinafter, simply referred to “group P”) was brought into an activated state. A task that discriminates a speaker was set in the group P.

Numerals that bring the group P into an activated state (hereinafter, referred to as “wake words”) were changed within a range from 0 to 9, and an experiment was performed using 300 test data with respect to each wake word. 30 wake words were contained in the 300 test data, and hence, ideally, the group P should be activated only when 30 test data of the above-mentioned wake words are given.

The experiment result was as follows.

Out of 300 times at which test data was the wake word, the number of times the group Q brought the group P into an activated state was 266 times.

Out of 2700 times when the test data was not the wake words, the number of times the group Q erroneously brought the group P into an activated state was 34 times.

Out of 300 times where the group P was brought into an activated state, the number of times a speaker was correctly discriminated was 283 times.

Although the embodiments of the present invention have been described above, the present invention is not limited to the above-mentioned modes. Further, any change of conditions and the like that do not depart from the gist of the present invention all fall within the scope of the present invention.

For example, the output layer may include a plurality of nodes.

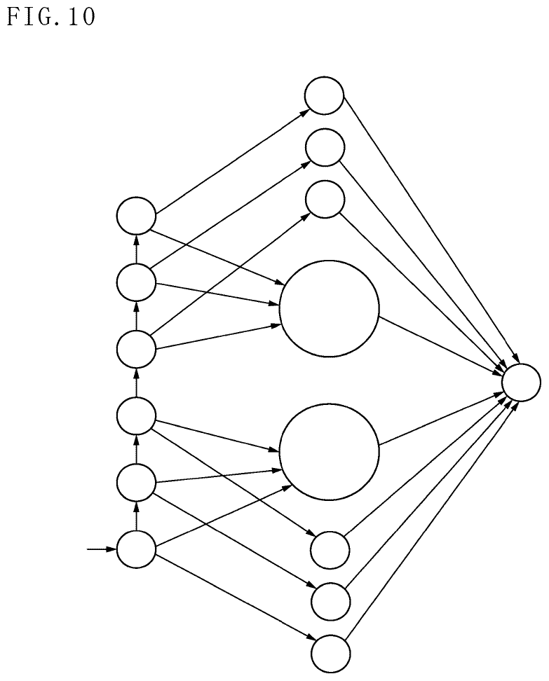

Further, the reservoir computing device according to the above-mentioned second embodiment and the reservoir computing device according to the above-mentioned third embodiment can be combined with each other. To be more specific, as illustrated in FIG. 10, an input layer is constituted of a plurality of groups, and the reservoir layer is constituted of a plurality of groups (large circles arranged in the left and right directions as viewed from the center of the reservoir layer in FIG. 10) to which signals are given from only specific groups in the input layer, and besides such plurality of groups in the reservoir layer, a node C (small circles arranged in the left and right directions as viewed from the center of the reservoir layer in FIG. 10) may be provided in the reservoir layer.

### INDUSTRIAL APPLICABILITY

The reservoir computing device and the reservoir computing program according to the present invention can realize a reservoir computing model having high performance where both a non-linear transformation characteristic and a storage capacity of the reservoir layer are set to predetermined values or more. Accordingly, for example, chips and electronic circuits that perform complicated identification processing and prediction processing can be made more compact.

### REFERENCE SIGNS LIST

10: reservoir computing device, 11: input layer, 12: reservoir layer, 13: output layer, 14, 14a, 14b, 14c, 14d, 14e, 14f, 15, 16: node, 20: reservoir computing device, 21: input layer, 21a, 21b: input means, 22: reservoir layer, 22a, 22b: reservoir means, 23: output layer, 24, 24a, 24b, 24c, 24d, 24e, 26, 27, 28: node, 30: reservoir computing device, 31: input layer, 32: reservoir layer, 33: output layer, 34, 34a, 35: node, 36: reservoir means, 37, 37a, 38: node, 40: reservoir computing device, 41: input layer, 41a, 41b: input means, 42: reservoir layer, 42a, 42b: reservoir means, 43: output layer, 43a, 43b: output means, 44, 44a, 44b, 44c, 44d, 44e, 46, 47, 48, 49: node, 50: activation means

1. A reservoir computing device comprising:
an input layer;
a reservoir layer that outputs a signal reflecting the signal given from the input layer; and
an output layer that derives an output value based on the signal outputted from the reservoir layer, wherein
the input layer has a plurality of nodes A,
at least one node A is given a signal reflecting the signal outputted from another node A in one step, and
a signal reflecting the given signal is given to the reservoir layer in a subsequent step.

2. The reservoir computing device according to claim 1, wherein
the input layer and the reservoir layer each include a plurality of groups, and each group of the reservoir layer is given the signal only from a specific group of the input layer.

3. The reservoir computing device according to claim 2, wherein
the plurality of groups in the reservoir layer include: a group P in which the reservoir layer is switched from an activated state where the reservoir layer is given the signal from the input layer and outputs the signal to the output layer to a sleep state in which processing of outputting the signal is not performed even when the reservoir layer is given the signal from the input layer under a predetermined condition; and a group Q in which the reservoir layer is in the activated state normally, and the group P in the sleep state is switched to the activated state when the output layer to which the signal is outputted from the group Q derives the preset output value.

4. The reservoir computing device according to claim 1, wherein
the reservoir layer includes a node C to which a signal is directly given from the node A in one step and outputs a signal reflecting the given signal to the output layer in a subsequent step, and the node C is not connected to another node in the reservoir layer.

5. The reservoir computing device according to claim 1, wherein
a sum-of-product operation is applied to a signal outputted from the reservoir layer.

6. The reservoir computing device according to claim 1, wherein
the reservoir computing device performs processing based on Chaotic Boltzmann Machine.

7. A reservoir computing program executed to enable an information processing terminal, for deriving an output value based on a given signal,
to function as an input means that has a plurality of node A, a reservoir means that outputs a signal reflecting a signal that is given from the input means, and an output means that derives the output value based on the signal outputted from the reservoir means, and
to perform processing that includes: a step where at least the one node A is given a signal reflecting a signal outputted from another node A; and a step where the node A to which the signal is given gives a signal reflecting the given signal to the reservoir means.

8. The reservoir computing program according to claim 7, wherein
the input means and the reservoir means are provided in plural respectively, and
the program is executed to enable the information processing terminal to make the plurality of reservoir means perform processing where a signal is given from only the specific input means respectively.

9. The reservoir computing program according to claim 8, wherein
the plurality of reservoir means consists of: a reservoir means p that is switched from an activated state where the signal is given from the input means and the signal is outputted to the output means to a sleep state in which processing of outputting the signal is not performed even when the signal is given from the input means; and a reservoir means q in which the reservoir layer is in the activated state normally,
the reservoir computing program is executed so as to enable the information processing terminal to perform processing where the reservoir means p in the sleep state is switched to the activated state when the output means to which a signal is outputted from the reservoir means q derives the preset output value.

10. The reservoir computing program according to claim 7, wherein
the program enables the information processing terminal to function also as a node C to which a signal is directly given from the node A, and
the program enables the information processing terminal such that the node C outputs a signal reflecting a signal given to the node C to the output means, only the node A is set as a transmission source of the signal to the node C, and only the output means is set as an output destination of the signal from the node C.

11. A reservoir utilization calculation method for deriving an output value based on an input signal inputted externally, the method comprising:
a step of allowing a first node to give an M-th input signal inputted to the first node externally to a reservoir operation unit, and allowing the first node to output the M-th input signal to a second node; and
a step of allowing the first node to give a (M+1)-th input signal inputted to the first node externally to a reservoir operation unit, allowing the first node to output the (M+1)-th input signal to the second node, and further, allowing the second node to give a signal reflecting the M-th input signal to the reservoir operation unit.
